(19) United States
(12) Patent Application Publication
(10) Pub. No.: US 2011/0290533 A1
(43) Pub. Date: Dec. 1, 2011

(54) INSULATOR

(76) Inventor: Desai ZHANG, Wuhan (CN)

(21) Appl. No.: 13/111,991

(22) Filed: May 20, 2011

Related U.S. Application Data
(63) Continuation of application No. PCT/CN2009/074960, filed on Nov. 16, 2009.

(30) Foreign Application Priority Data
Nov. 20, 2008 (CN) 200810197722.5

(51) Int. Cl. H01B 17/00

(52) U.S. Cl. 174/177

(57) ABSTRACT

An insulator including an upper electrode and a lower electrode with an upper barrier and a lower barrier disposed outside respectively. The barriers can prevent moving charge from moving from one area to another and modify the electric field distribution within a concentrated area. Meanwhile, they also help to largely increase corona voltage and flashover voltage, reduce power loss in HV power transmission lines and radio interference, and mitigate degradation of insulators.

### CROSS-REFERENCE TO RELATED APPLICATIONS

This application is a continuation of International Patent Application No. PCT/CN2009/074960 with an international filing date of Nov. 16, 2009, designating the United States, now pending, and further claims priority benefits to Chinese Patent Application No. 200810197722.5 filed Nov. 20, 2008. The contents of all of the aforementioned applications, including any intervening amendments thereto, are incorporated herein by reference.

### BACKGROUND OF THE INVENTION

1. Field of the Invention

The invention relates to an insulator.

2. Description of the Related Art

In current power system, an insulator is a device used to fix power lines and allow them to remain a certain insulation distance from the ground. Conventional insulators mainly include three types, i.e., line insulators, post insulators, and pothead insulators. Line insulators are used to fix and insulate overhead transmission lines, post insulators to support and insulate live parts of high voltage (HV) electrical equipment, and pothead insulators to provide protection for live conductors passing through metal casings of HV electrical equipment or for bus passing through walls.

Conventional insulators, however, have the following disadvantages: 1. when a moving charge moves from one area to another, the electric field is distributed unevenly in various areas and a concentrated area often exist; 2. low flashover voltage; 3. large radio interference, large power loss in high-voltage power transmission lines, and degradation of insulators; 4. low contamination flashover voltage; 5. low wet flashover voltage in case insulator surface becomes wet in rain; and 6. low external insulation strength.

### SUMMARY OF THE INVENTION

In view of the above-described problems, it is one objective of the invention to provide an insulator with improved external insulation strength.

To achieve the above objective, in accordance with one embodiment of the invention, there provided is an insulator comprising an upper electrode and a lower electrode, and an upper and a lower barrier are disposed outside the upper and the lower electrode of the insulator, respectively.

In a class of this embodiment, the insulator is a pin type insulator, a porcelain line post insulator, a composite line post insulator, a porcelain rod suspension insulator, a composite rod suspension insulator, a substation support insulator, a porcelain pothead insulator, or a cantilever insulator for electrified railway system.

In a class of this embodiment, the upper and lower barriers are either fixed or removable barriers.

In accordance with another embodiment of the invention, there provided is an insulator string comprising a first insulator comprising an upper electrode, a second insulator, and a third insulator, wherein the first insulator is located at the top of the insulator string; the second insulator is located in a middle serial connection part of the insulator string; an upper barrier is disposed outside the upper electrode of the first insulator; and a middle barrier is disposed outside a serial connection part between the second and third insulator.

In a class of this embodiment, the insulator string is a porcelain or glass disc suspension insulator string.

In a class of this embodiment, the upper and middle barriers are either fixed or removable barriers.

In accordance with still another embodiment of the invention, there provided is an insulator string comprising a serial electrode, wherein the serial electrode is located in the middle of the insulator string and comprises a middle barrier disposed outside.

In a class of this embodiment, the insulator string is a porcelain rod suspension insulator string.

In a class of this embodiment, the middle barrier is an either fixed or removable barrier.

In accordance with still another embodiment of the invention, there provided is an insulator comprising an upper equalizing ring with an upper ring barrier disposed outside.

The insulator is a rod suspension insulator.

In a class of this embodiment, the upper ring barrier is an either fixed or removable barrier.

In accordance with still another embodiment of the invention, there provided is an insulator comprising a lower equalizing ring with a lower ring barrier disposed outside.

In a class of this embodiment, the lower ring barrier is an either fixed or removable barrier.

In accordance with still another embodiment of the invention, there provided is an insulator comprising an upper electrode, a lower electrode, a serial electrode, and an upper equalizing ring, wherein the serial electrode is located in the middle of the insulator; an upper barrier and a lower barrier are disposed outside the upper electrode and lower electrode, respectively; a middle barrier is disposed outside the serial electrode; and an upper ring barrier is disposed outside the upper equalizing ring.

In a class of this embodiment, the upper barrier, lower barrier, middle barrier, and upper ring barrier are either fixed or removable barriers.

In accordance with still another embodiment of the invention, there provided is an insulator comprising a dielectric and a suspension electrode, wherein the suspension electrode is disposed on the dielectric and a middle barrier is disposed near the suspension electrode.

In a class of this embodiment, the insulator is a long post insulator, a long composite suspension insulator, or a long pothead insulator.

In a class of this embodiment, the middle barrier is an either fixed or removable barrier.

In accordance with still another embodiment of the invention, there provided is an insulator, wherein the insulator is mounted near an iron tower and a transmission line; an iron tower barrier and a transmission line barrier are disposed near the insulator; and the iron tower barrier and transmission line barrier are either fixed or removable barriers.

Advantages of the invention are summarized below: 1. Barriers provided in this invention can prevent moving charges from moving from one area to another, lower the electric field strength, and modify the electric field distribution within a concentrated area; 2. Space charges on the barrier surface change discharge path, intensify discharge classification, prolong discharge time, thereby significantly improving an insulator's flashover voltage; 3. As barriers provided in this invention help to increase initial corona voltage, they can reduce power loss in HV power transmission lines and radio interference and mitigate degradation of insulators; 4 Barriers, made of organic materials, help to prolong creepage distance and thus increase contamination flashover voltage of the insulator; 5. Barriers are able to reduce the area of insulator surface getting wet in rain to increase wet flashover voltage; and 6. Barriers make it possible for conventional insulators to unify together with iron towers and transmission lines, and thus external insulation strength of the insulator is improved.

### BRIEF DESCRIPTION OF THE DRAWINGS

FIG. 1 is a front view of a porcelain pin type insulator comprising a barrier according to one embodiment of the invention;

FIG. 2 is a front view of a porcelain line post insulator comprising a barrier according to one embodiment of the invention;

FIG. 3 is a front view of a composite line post insulator comprising a barrier according to one embodiment of the invention;

FIG. 4 is a front view of a porcelain/glass disc suspension insulator string comprising a barrier disposed on a top first insulator according to one embodiment of the invention;

FIG. 5 is a front view of a porcelain/glass disc suspension insulator string comprising a barrier disposed at a middle serial connection part of an insulator according to one embodiment of the invention;

FIG. 6 is a front view of a porcelain rod suspension insulator comprising a barrier according to one embodiment of the invention;

FIG. 7 is a front view of a composite line rod suspension insulator comprising a barrier according to one embodiment of the invention;

FIG. 8 is a front view of a porcelain line rod suspension insulator comprising a barrier disposed at a middle serial connection part of an insulator according to one embodiment of the invention;

FIG. 9 is a front view of a line insulator with an upper equalizing ring comprising a barrier according to one embodiment of the invention;

FIG. 10 is a front view of a line insulator with a lower equalizing ring comprising a barrier according to one embodiment of the invention;

FIG. 11 is a front view of a substation support insulator comprising a barrier according to one embodiment of the invention;

FIG. 12 is a front view of an insulator stack formed by several post insulators comprising a barrier according to one embodiment of the invention;

FIG. 13 is a front view of a pothead insulator comprising a barrier according to one embodiment of the invention;

FIG. 14 is a front view of a long post insulator comprising a suspension electrode and a barrier according to one embodiment of the invention;

FIG. 15 is a front view of a long composite suspension insulator comprising a suspension electrode and a barrier according to one embodiment of the invention;

FIG. 16 is a front view of another long composite suspension insulator comprising a suspension electrode and a barrier according to one embodiment of the invention;

FIG. 17 is a front view of a long pothead insulator comprising a suspension electrode and a barrier according to one embodiment of the invention;

FIG. 18 is a front view of a cantilever insulator for electrified railway system comprising a barrier according to one embodiment of the invention; and

FIG. 19 is a front view of an iron tower comprising a barrier nearby according to one embodiment of the invention.

### DETAILED DESCRIPTION OF THE EMBODIMENTS

The invention is explained in further detail below with the reference to the attached drawings.

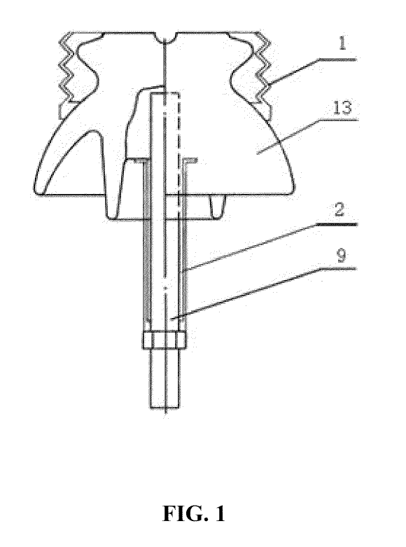

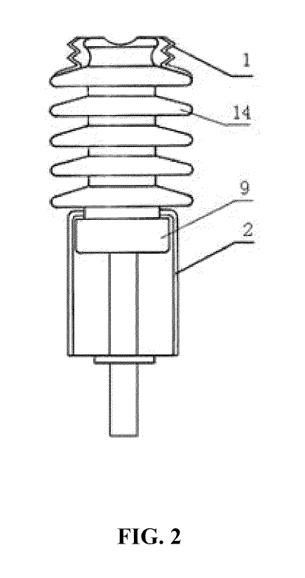

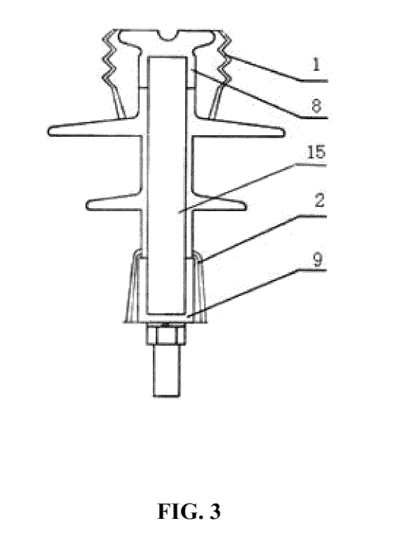

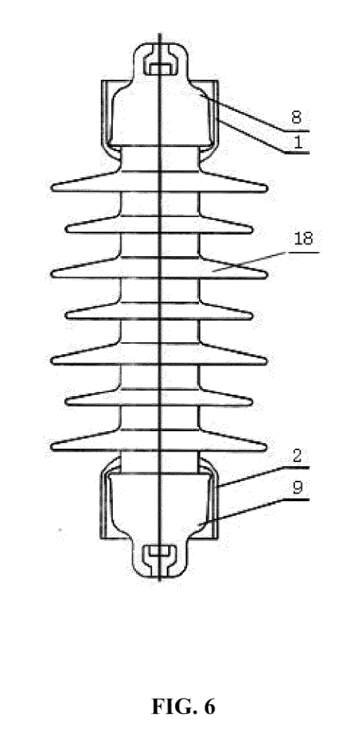

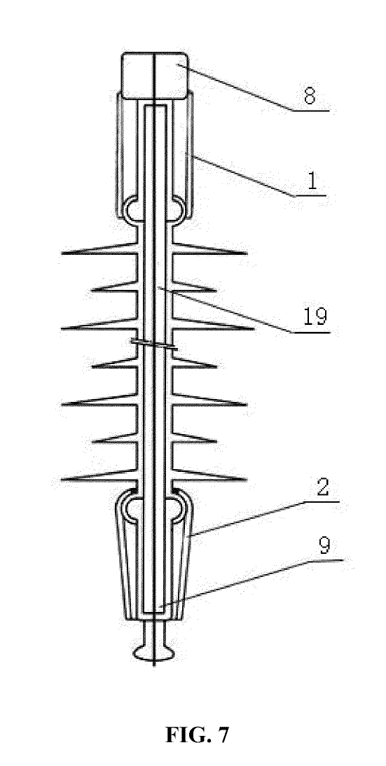

As shown in FIGS. 1, 2, 3, 6, 7, and 13, an upper barrier 1 and a lower barrier 2 are separately disposed outside an upper electrode 8 and a lower electrode 9 of a pin type insulator 13, a porcelain line post insulator 14, a composite line post insulator 15, a porcelain rod suspension insulator 18, a composite rod suspension insulator 19, and a porcelain pothead insulator 25.

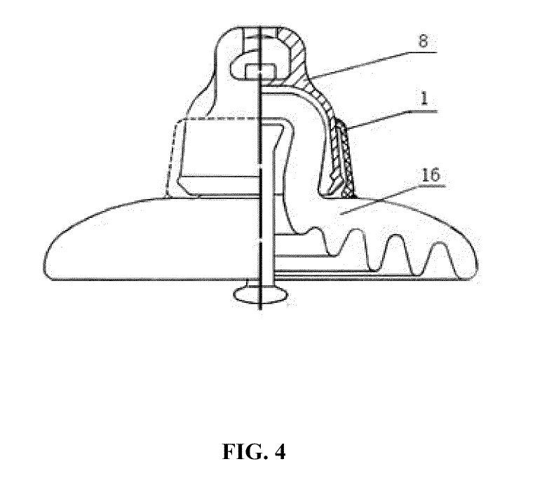

As shown in FIG. 4, the upper barrier 1 is disposed outside the upper electrode 8 of a first insulator 16 which is on the top of a porcelain disc suspension insulator string.

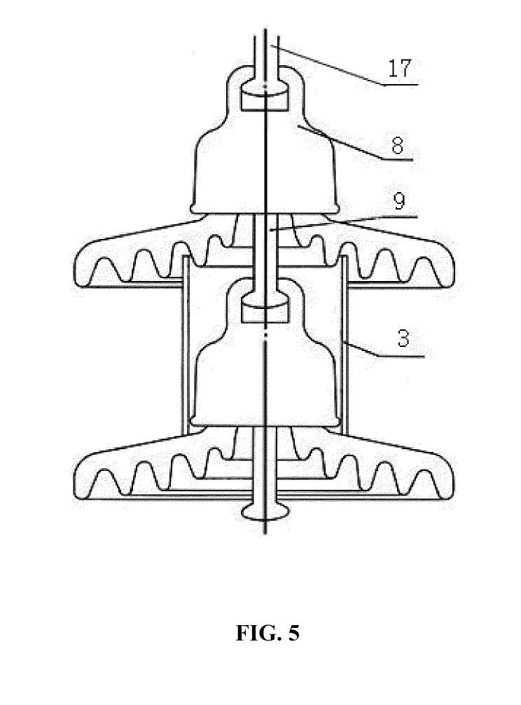

As shown in FIG. 5, the upper barrier 1 is disposed outside the upper electrode 8 of a porcelain or glass disc suspension insulator string 17 and a middle barrier 3 is disposed at a middle serial connection part and outside a last insulator at the bottom.

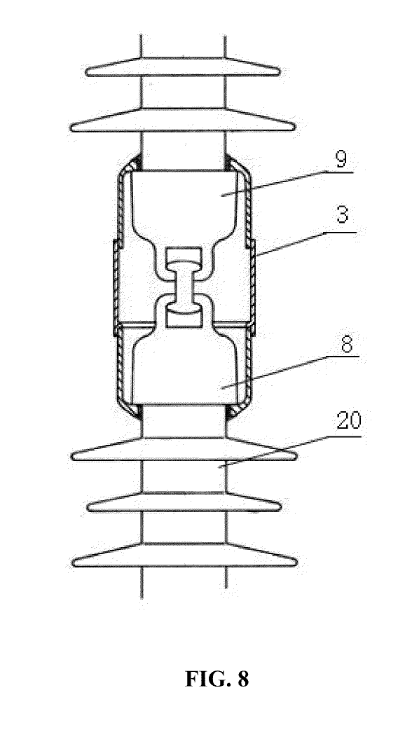

As shown in FIG. 8, the middle barrier 3 is disposed outside a middle serial connection part of a porcelain rod suspension insulator string 20.

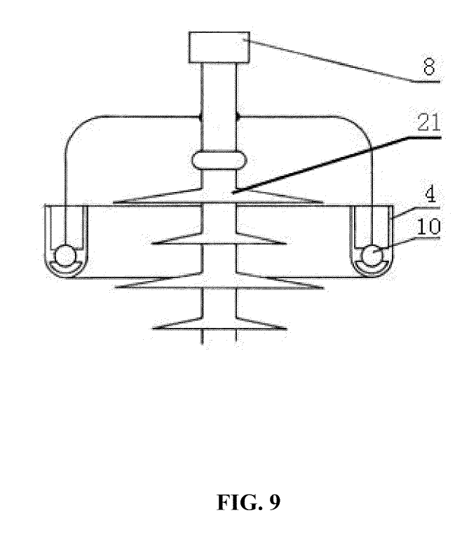

As shown in FIG. 9, an upper ring barrier 4 is disposed outside an upper equalizing ring 10 of a rod suspension insulator 21 and the upper ring barrier 4 also applies for an upper equalizing ring of a porcelain/glass insulator string.

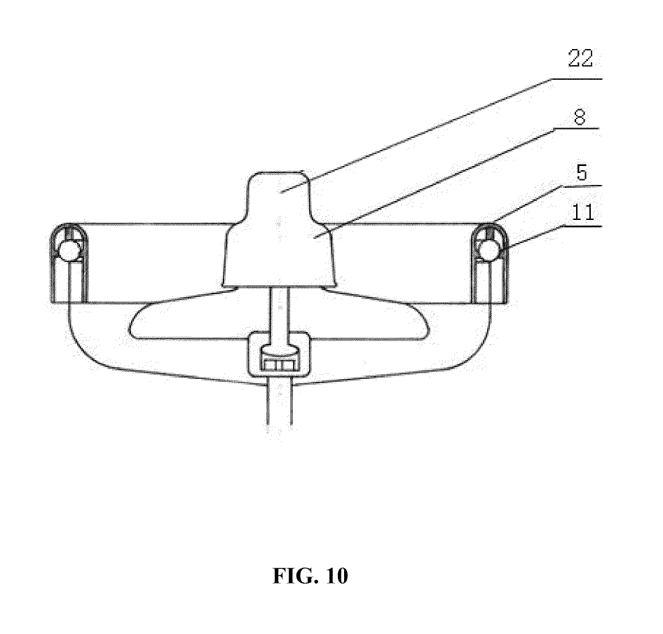

As shown in FIG. 10, a lower ring barrier 5 is disposed outside a lower equalizing ring 11 of an insulator string 22 and the lower ring barrier 5 also applies for a lower equalizing ring of a composite insulator.

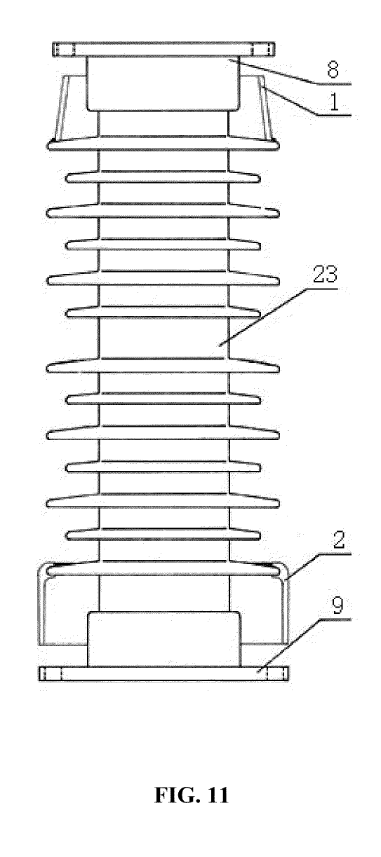

As shown in FIG. 11, the upper barrier 1 and the lower barrier 2 are disposed outside the upper electrode 8 and the lower electrode 9 of a substation support insulator 23 respectively. The lower barrier 2 can also be fixed between two sheds.

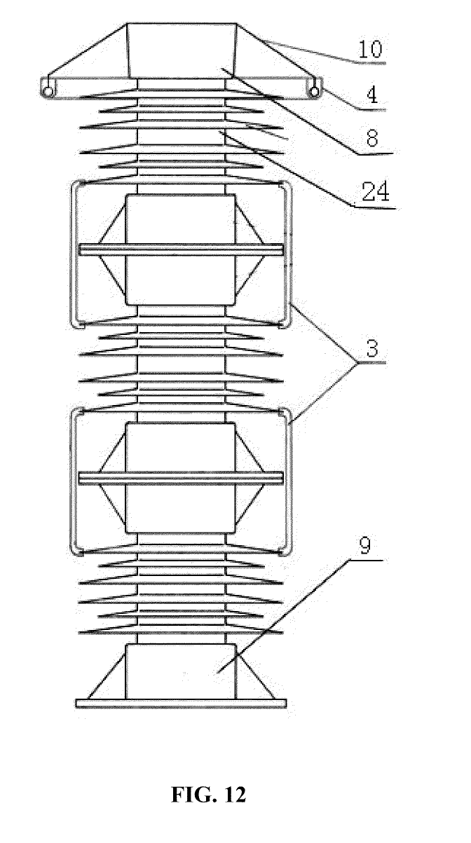

As shown in FIG. 12, an insulator stack 24 formed by several post insulators, in which the upper barrier 1 and the lower barrier 2 are disposed outside the upper electrode 8 and the lower electrode 9 of the insulator stack 24 respectively while the middle barrier 3 and the upper ring barrier 4 are disposed outside the middle serial connection part and the upper equalizing ring 10 respectively. The middle barrier 3 can also be fixed between two sheds.

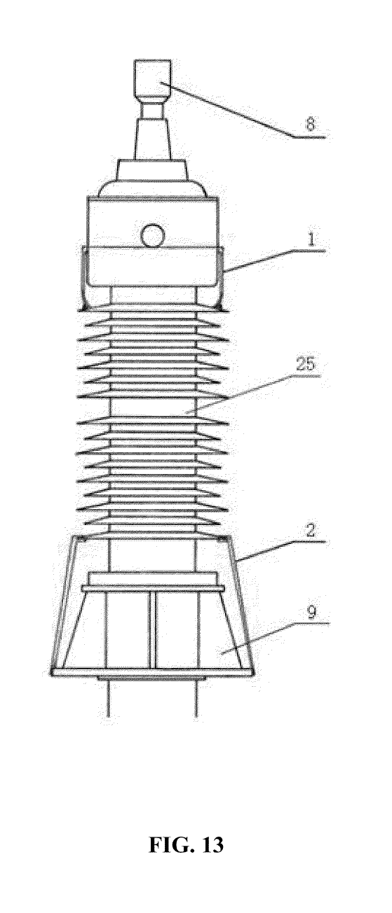

As shown in FIG. 13, the lower barrier 2 can also be fixed between two sheds of the porcelain pothead insulator 25 and the lower barrier 2 also applies for a composite pothead insulator.

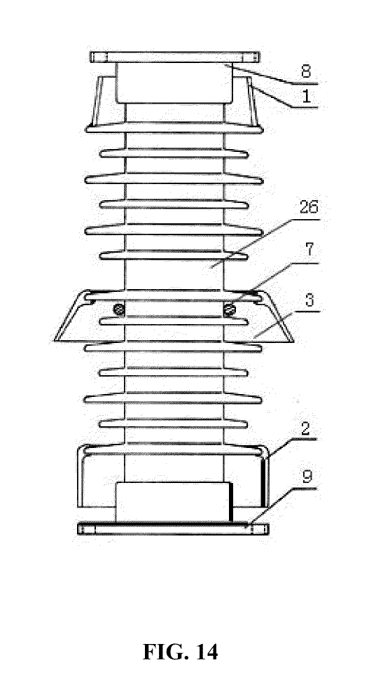

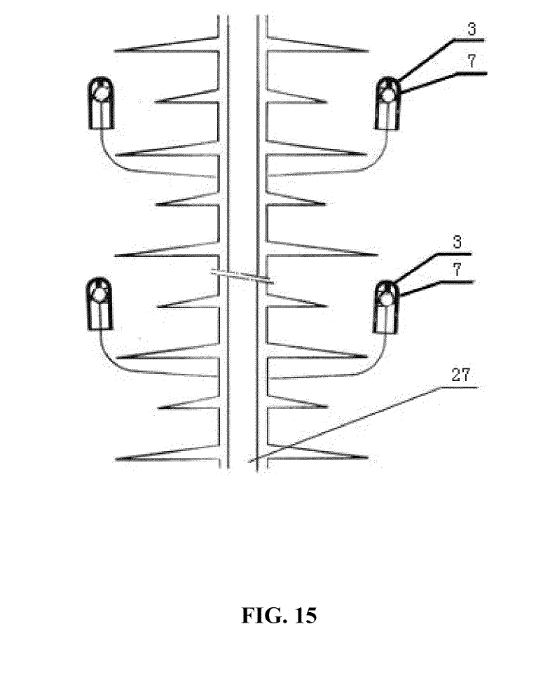

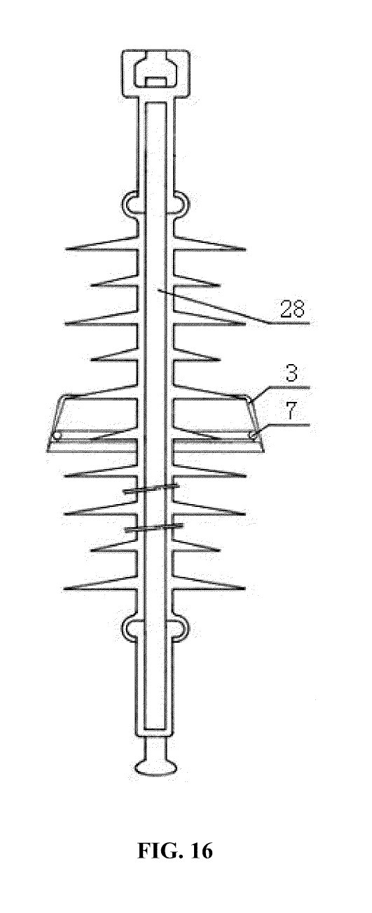

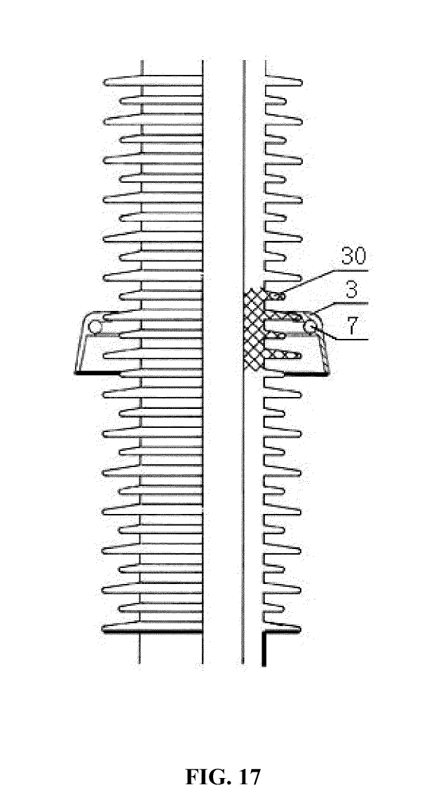

As shown in FIGS. 14, 15, 16 and 17, when the insulation distance of a long post insulator 26, a long composite suspension insulator 27, another long composite suspension insulator 28, and a long pothead insulator 30 exceeds 1 m and there is no suspension electrode or the suspension electrode distance of the insulators exceeds 1 m, a suspension electrode 7 has to be first disposed on a dielectric of the long post insulator 26, the long composite suspension insulator 27, another long composite suspension insulator 28, and the long pothead insulator 30 so as to reduce the distance of each suspension electrode to less than 1 m and then arrange the middle barrier 3 near the suspension electrode 7. The middle barrier 3 can also be fixed between two sheds.

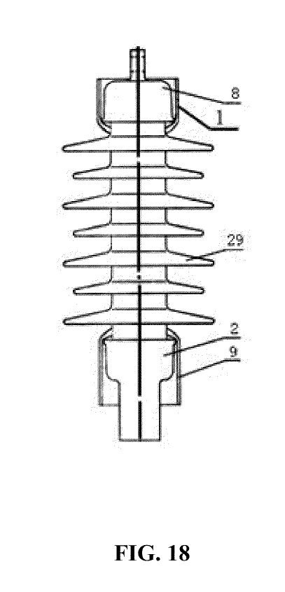

As shown in FIG. 18, the upper barrier 1 and the lower barrier 2 are disposed outside the upper electrode 8 and the lower electrode 9 of a cantilever insulator for an electrified railway system 29 respectively.

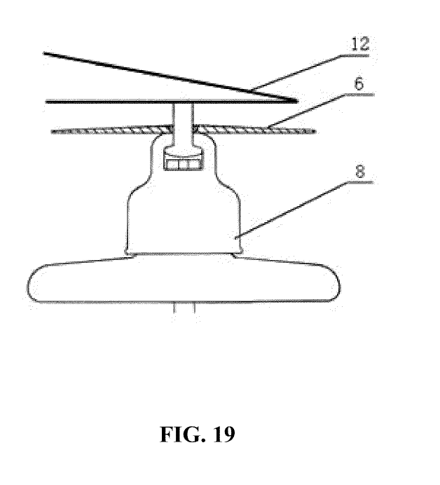

As shown in FIG. 19, an insulator is mounted near an iron tower 12 and a transmission line, and an iron tower barrier 6 and a transmission line barrier are disposed near the insulator. The iron tower barrier 6 and the transmission line barrier make it possible for conventional insulators to unify together with iron towers and transmission lines and to improve external insulation strength of the insulator.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An insulator, comprising:
an upper electrode; and
a lower electrode;
wherein
an upper barrier is disposed outside said upper electrode of said insulator; and
a lower barrier is disposed outside said lower electrode of said insulator.

2. The insulator of claim 1, wherein said insulator is a pin type insulator, a porcelain line post insulator, a composite line post insulator, a porcelain rod suspension insulator, a composite rod suspension insulator, a substation support insulator, a porcelain pothead insulator, or a cantilever insulator for electrified railway system.

3. The insulator of claim 1, wherein said upper/lower barriers are either fixed or removable barriers.

4. An insulator string, comprising:
a first insulator with an upper electrode;
a second insulator; and
a third insulator;
wherein
said first insulator is located at the top of said insulator string;
said second insulator is located at a middle serial connection part of said insulator string;
an upper barrier is disposed outside said upper electrode of said first insulator; and
a middle barrier is disposed outside a serial connection part between said second and said third insulator.

5. The insulator string of claim 4, wherein said insulator string is a porcelain or glass disc suspension insulator string.

6. The insulator of claim 4, wherein said upper barrier and middle barrier are either fixed or removable barriers.

7. An insulator string, comprising:
a serial electrode;
wherein
said serial electrode is located in the middle of said insulator string, and
a middle barrier is disposed outside said serial electrode.

8. The insulator string of claim 7, wherein said insulator string is a porcelain rod suspension insulator string.

9. The insulator string of claim 7, wherein said middle barrier is an either fixed or removable barrier.

10. An insulator, comprising:
an upper equalizing ring;
wherein
an upper ring barrier is disposed outside said upper equalizing ring.

11. The insulator of claim 10, wherein said insulator is a rod suspension insulator.

12. The insulator of claim 10, wherein said upper ring barrier is an either fixed or removable barrier.

13. An insulator string, comprising:
a lower equalizing ring;
wherein
a lower ring barrier is disposed outside said lower equalizing ring.

14. The insulator string of claim 13, wherein said lower ring barrier is an either fixed or removable barrier.

15. An insulator, comprising:
an upper electrode;
a lower electrode;
a serial electrode; and
an upper equalizing ring;
wherein
said serial electrode is located in the middle of said insulator;
an upper barrier is disposed outside said upper electrode;
a lower barrier is disposed outside said lower electrode;
a middle barrier is disposed outside said serial electrode; and
an upper ring barrier is disposed outside said upper equalizing ring.

16. The insulator of claim 15, wherein said upper barrier, lower barrier, middle barrier and upper ring barrier are either fixed or removable barriers.

17. An insulator, comprising:
a dielectric; and
a suspension electrode;
wherein
said suspension electrode is disposed on said insulator; and
a middle barrier is disposed near said suspension electrode.

18. The insulator of claim 17, wherein said insulator is a long post insulator, a long composite suspension insulator, or a long pothead insulator.

19. The insulator of claim 17, wherein said middle barrier is an either fixed or removable barrier.

20. An insulator mounted near an iron tower and a transmission line, wherein an iron tower barrier and a transmission line barrier are disposed near said insulator, and said iron tower barrier and transmission line barrier are either fixed or removable barriers.
